(19) United States
(12) Patent Application Publication
(10) Pub. No.: US 2014/0368539 A1
(43) Pub. Date: Dec. 18, 2014

(54) HEAD WEARABLE ELECTRONIC DEVICE FOR AUGMENTED REALITY AND METHOD FOR GENERATING AUGMENTED REALITY USING THE SAME

(71) Applicant: ARSENZ CO., LTD., NEW TAIPEI CITY (TW)

(72) Inventor: HSIU-CHI YEH, NEW TAIPEI CITY (TW)

(73) Assignee: ARSENZ CO., LTD., NEW TAIPEI CITY (TW)

(21) Appl. No.: 14/182,457

(22) Filed: Feb. 18, 2014

(30) Foreign Application Priority Data
Jun. 13, 2013 (TW) 102120873

(51) Int. Cl. G06T 11/60; G02B 27/01

(52) U.S. Cl. CPC G06T 11/60; G02B 27/017
USPC 345/633

(57) ABSTRACT

A head wearable electronic device has an image acquisition module, a physical characteristics recognition module, a see-through display module and a processing module, and a method for generating augmented reality is performed by the head wearable electronic device, and includes using the image acquisition module to acquire a first-person view (FPV) streaming video of a surrounding environment, using the processing module to calculate a stream of depth maps of an object and a body portion in the FPV streaming video of the surrounding environment according to the FPV streaming video, using the physical characteristics recognition module to keep track of the body portion and output motion data of the body portion, and using the processing module to display a virtual streaming video on the see-through display module according to the motion data and the stream of depth maps of the object and the body portion.

### BACKGROUND OF THE INVENTION

1. Field of the Invention

The present invention relates to a head wearable electronic device, and more particularly to a head wearable electronic device for augmented reality and a method for generating augmented reality using the same.

2. Description of the Related Art

Visual sense is the most simple and direct means for mankind to access information of a surrounding environment. When technology was not mature enough, human beings can only see objects actually existing in a real physical environment. The acquired information was limited and insufficient to meet boundless human curiosity and desire to learn.

Augmented reality is one type of virtual reality technique applied to a virtual image or view combined with a surrounding environment observed by users. Augmented reality can provide more instant and diversified information, especially those not directly available to users' naked eyes, thereby significantly enhancing operational convenience for users to instantaneously interact with the surrounding environment.

Owing to the breakthrough in displays and transmission techniques, nowadays, manufacturers have rolled out augmented reality products, such as a pair of electronic eyeglasses 70 as shown in FIG. 7. The pair of electronic eyeglasses has a see-through display and projection lens 71, a camera module 72, a sensing module 73, a wireless transmission module 74, a processing module 75 and a recognition module 76. After the wireless transmission module 74 receives positioning data, the camera module 72 takes pictures of the surrounding environment, the recognition module 76 recognizes objects inside the pictures, the sensing module 73 senses temperature and brightness in the surrounding environment, and the processing module 75 provides time information. With reference to FIG. 8, all the information is combined and then displayed on the see-through display and projection lens 71 such that users can simultaneously see objects 80 in the surrounding environment and desired digital information through the pair of electronic eyeglasses 70 to expand contents in the surrounding environment viewed by users.

However, the foregoing application is still far behind real interaction. As illustrated in FIG. 8, the virtual content displayed thereon correlates with the objects in the surrounding environment only in terms of location. For example, an annotation “A building” displayed beside the A building 80 fails to utilize distances between the objects in the surrounding environment in rendering virtual images with depth maps. Furthermore, the augmented reality content provided by the pair of electronic eyeglasses 70 also fails to interactively respond to limb movements of users, making the virtual image displayed by the pair of electronic eyeglasses 70 short of sense of reality.

Accordingly, how to provide a device and a method for generating augmented reality, which can utilize a stream of depth maps in a surrounding environment and users' motion information, and further let augmented reality contents interact with the surrounding environment viewed by users and users' motion, becomes one of the most important topics in the art.

### SUMMARY OF THE INVENTION

A first objective of the present invention is to provide a head wearable electronic device and a method for generating augmented reality using the head wearable electronic device for augmented reality utilizing a stream of depth maps in a surrounding environment and users' motion data for augmented reality contents to smoothly interact with the surrounding environment and users' motion.

To achieve the foregoing objective, the method for generating augmented reality is performed by a head wearable electronic device having at least one image acquisition module, a physical characteristics recognition module, at least one see-through display module, and a processing module. The method has steps of:

using the at least one image acquisition module to acquire at least one first-person view (FPV) streaming video of a surrounding environment;

using the processing module to calculate a stream of depth maps of at least one object and a body portion in the at least one FPV streaming video of the surrounding environment according to the at least one FPV streaming video of the surrounding environment;

using the physical characteristics recognition module to keep track of the body portion and output motion data of the body portion; and

using the processing module to display at least one virtual streaming video on the respective see-through display module according to the motion data and the stream of depth maps of the at least one object and the body portion.

To achieve the foregoing objective, the head wearable electronic device for augmented reality has at least one image acquisition module, a processing module, a physical characteristics recognition module, and at least one see-through display module.

The at least one image acquisition module respectively acquires at least one first-person view (FPV) streaming video of a surrounding environment. The at least one FPV streaming video of the surrounding environment includes at least one object and a body portion.

The processing module is coupled to the at least one image acquisition module, and calculates a stream of depth maps of the at least one object and the body portion surrounding environment according to the at least one FPV streaming video of the surrounding environment.

The physical characteristics recognition module is coupled to the processing module, keeping track of the body portion in the at least one FPV streaming video of the surrounding environment, and outputting motion data corresponding to the body portion.

The at least one see-through display module is coupled to the processing module, and displaying at least one virtual streaming video on the respective see-through display module according to the motion data and the stream of depth maps of the body portion.

The foregoing method for generating augmented reality and the head wearable electronic device for augmented reality respectively calculate the stream of depth maps of the at least one object and the body portion in a surrounding environment and further keep track of users' motion with the physical characteristics recognition module to establish a 3D (three-dimensional) interactive relationship among users, the at least one object, and the surrounding environment. In other words, supposing that objects are located at different locations relative to a user in the surrounding environment and when the user's hand moves different distances, the head wearable electronic device for augmented reality and the method for generating augmented reality determine that the user's hand tries to interact with the objects and provides users with different augmented contents to closely combine the FPV streaming video of surrounding environment with the virtual streaming video.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a head wearable electronic device for augmented reality in accordance with the present invention;

FIG. 2 is a functional block diagram of the head wearable electronic device for augmented reality in FIG. 1;

FIGS. 3a and 3b are operational schematic views of one image of a FPV streaming video of a surrounding environment taken when the head wearable electronic device in FIG. 1 is operated;

FIG. 3c is an operational schematic view showing when the head wearable electronic device for augmented reality generates one image of a virtual streaming video interacting with a surrounding environment;

FIG. 3d is an operational schematic view showing when the head wearable electronic device for augmented reality generates one image of another virtual streaming video interacting with a surrounding environment;

FIG. 4 is a perspective view of a second embodiment of a head wearable electronic device for augmented reality in accordance with the present invention;

FIG. 5 is a functional block diagram of the head wearable electronic device for augmented reality in FIG. 4;

FIG. 6 is a flow diagram of a method for generating augmented reality using a head wearable electronic device in accordance with the present invention;

FIG. 7 is a conventional pair of electronic eyeglasses; and

FIG. 8 is a schematic view of augmented reality contents displayed by the pair of electronic eyeglasses in FIG. 7.

### DETAILED DESCRIPTION OF THE INVENTION

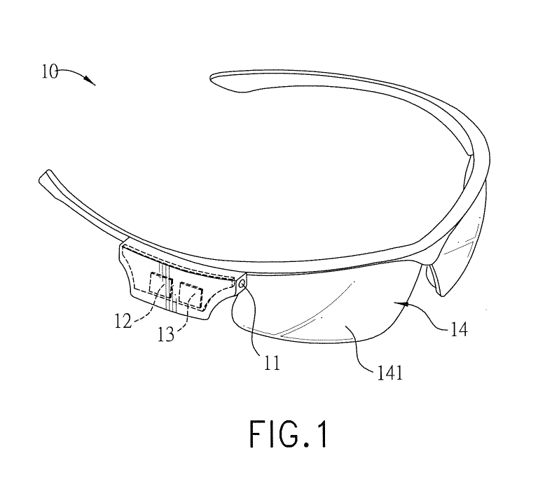

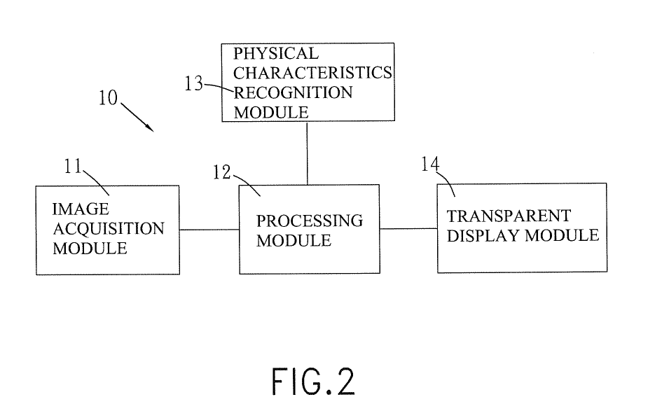

With reference to FIGS. 1 and 2, a first embodiment of a head wearable electronic device 10 for augmented reality in accordance with the present invention is a pair of electronic eyeglasses for displaying augmented reality, and has an image acquisition module 11, a processing module 12, a physical characteristics recognition module 13 and a see-through display module 14.

The processing module 12 may comprise a central processing unit (CPU), a graphic processing unit (GPU), an application-specific integrated circuit (ASIC) unit or a digital signal processing (DSP) unit that can perform signal processing, logic operations and algorithm to carry out functions of image processing, camera calibration, camera rectification, depth map calculation, 3D (three-dimensional) environment reconstruction, object recognition, and motion tracking and prediction, and all units of the processing module 12 can be mounted on a same circuit board to save space. The image acquisition module 11, the physical characteristics recognition module 13 and the see-through display module 14 are coupled to the processing module 12 and, preferably, are electrically connected to the processing module 12 to send signals or data to the processing module 12 for processing or to acquire signals or data outputted from the processing module 12. The head wearable electronic device 10 may further have one or more memory modules to accommodate various memories, and may have a platform for operation of a regular computer system, including a storage device, such as flash memory, a power circuit, and the like.

The image acquisition module 11 serves to acquire a first-person view (FPV) streaming video of a surrounding environment on a real-time basis. Specifically, the image acquisition module 11 may be a mini surveillance camera functioning to record a video. Preferably, the image acquisition module 11 records a video from the perspective of a user.

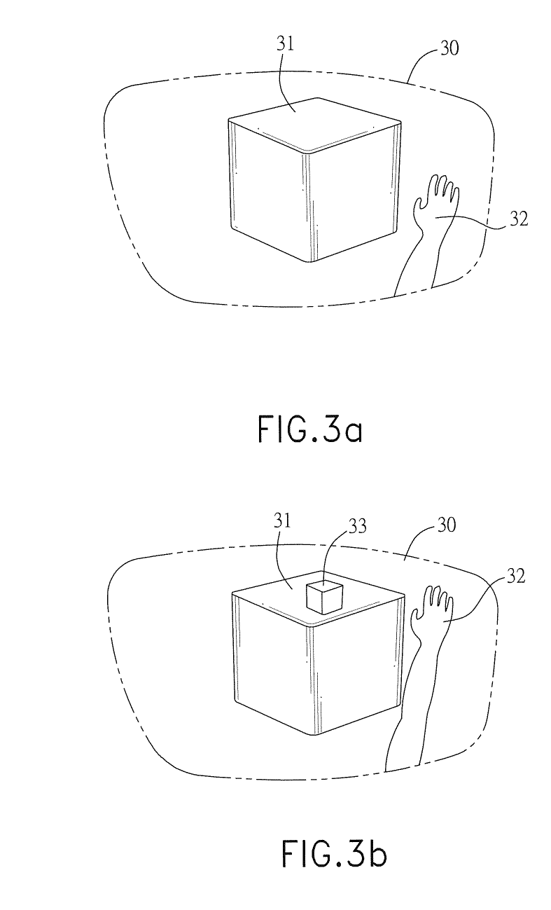

With reference to FIGS. 3a and 3b, operation of the head wearable electronic device is shown. In the present embodiment, each image 30 captured in the streaming video of the surrounding environment includes at least one object 31, such as a coffee table, and a body portion 32 of a user, such as a forearm and a palm of a hand.

The physical characteristics recognition module 13 serves to keep track of the user's motion and output motion data. The physical characteristics recognition module 13 has independent units of field programmable gate array (FPGA), ASIC, DSP, GPU and CPU for increasing response sensitivity and lowering delay in outputting the motion data. In the present embodiment, the processing module 12 is collaborated with one image acquisition module 11 to calculate a stream of depth maps of the object 31 and the body portion 32 using an optical flow algorithm according to the acquired images of the streaming video of the surrounding environment and to output the stream of depth maps of the object 31 and the body portion 32. The stream of depth maps of the object 31 and the body portion 32 may be contained in a combined depth map. After acquiring the stream of depth maps, the physical characteristics recognition module 13 uses criteria, such as contour, shape, color or distance, which can be obtained from—each depth map in the stream of depth maps, to extract the body portion 32, and converts the stream of depth maps of a part of the body portion into a 3D point cloud, maps a built-in or received 3D point cloud model, preferably a human figure simulation model, to the 3D point cloud, using a model-based hand tracking algorithm, to estimate the gesture of body portion 32. After a period of time, the physical characteristics recognition module 13 recognizes the body portion 32 again, compares an updated location of the body portion 32 with a last location thereof to achieve a motion-tracking function, and outputs motion data. The optical flow algorithm determines speed and direction of a moving object by detecting motion cue of pixels in images, which varies with time, and is omitted here as pertaining to the prior art. The physical characteristics recognition module 13 may be collaborated with an estimation algorithm to increase stability and speed in motion tracking.

After acquiring the stream of depth maps of the object 31 and the body portion 32 and the motion data, the processing module 12 computes to determine what movement the user takes to interact with the object 31 in the surrounding environment, and identifies a pre-defined command stored in the memory module or stored in a cloud system through data transmission, so as to display a corresponding virtual streaming video 33 on the see-through display module 14.

The see-through display module 14 may employ a half-reflecting mirror and a micro-projecting unit to display the virtual streaming video to be presented on a transparent glass plate 141 so that the user can still view the surrounding environment without being blocked by the virtual streaming video. The see-through display module 14 may be also achieved by using organic light-emitting diode (OLED) technique that fulfills the see-through display effect without requiring any backlight source due to the self-emitting nature of OLED.

With reference to FIG. 3c, while the present embodiment is implemented based on the foregoing description and the user views a coffee table 311 (an object) in the surrounding environment through the transparent glass plate 141, the image acquisition module 11 first acquires a streaming video of the coffee table 311 from the perspective of the user on a real-time basis. The head wearable electronic device 10 calculates a a stream of depth maps of the coffee table 311 according to the optical flow algorithm, and recognizes that the object is a coffee table according to the foregoing approach in recognizing objects. When the user's hand 321 also appears in the sight of the user, the head wearable electronic device 10 further calculates a stream of depth maps of the user's hand, and recognizes the user's hand by identifying and matching a stored hand model. It is also possible for the head wearable electronic device 10 to perform calculation and recognition while both the coffee table 311 and the hand 321 appear in the sight of the user.

While the user's hand 321 is approaching the coffee table 311, the physical characteristics recognition module 13 can keep track of motion of the hand 321 and output 3D motion data recognized in the surrounding environment. In contrast to conventional approaches recognizing only 2D (two-dimensional) motion on a touch panel, after detecting the 3D motion data of the hand 321 and combining the 3D motion data with the stream of depth maps, the head wearable electronic device 10 determines that the hand 321 is approaching the coffee table 311. After identifying a command in the memory module through the movement of the hand 321, the head wearable electronic device can output a control signal to the see-through display module 14 for the see-through display module 14 to display a virtual streaming video of a coffee cup 331 when the hand 321 reaches the coffee table 311. As the locations of the coffee cup 331 in the virtual streaming video corresponds to that of the coffee table 311 in the streaming video of the surrounding environment, the overall visual effect to the user creates an impression that the coffee cup 331 is placed on the coffee table 311 to generate an augmented reality result.

With reference to FIG. 3d, another virtual streaming video generated by the head wearable electronic device 10 and interacting with the surrounding environment is shown. When the head wearable electronic device 10 is operated and the user's hand is close to the coffee table and simulates a keyboard-punching movement, the head wearable electronic device 10 displays a virtual streaming video of a keyboard 331a on the see-through display module 14. In the present embodiment, the head wearable electronic device 10 may also have a sound effect module or a vibration module. Hence, when the user presses a specific key button, the head wearable electronic device 10 will recognize the particular movement or recognize the pressed key button and further generate other corresponding virtual streaming video, such as color change on the key button, activation of other virtual operation interface or generation of sound effect or vibration, as a response or feedback to the user's movement for more interactive effects.

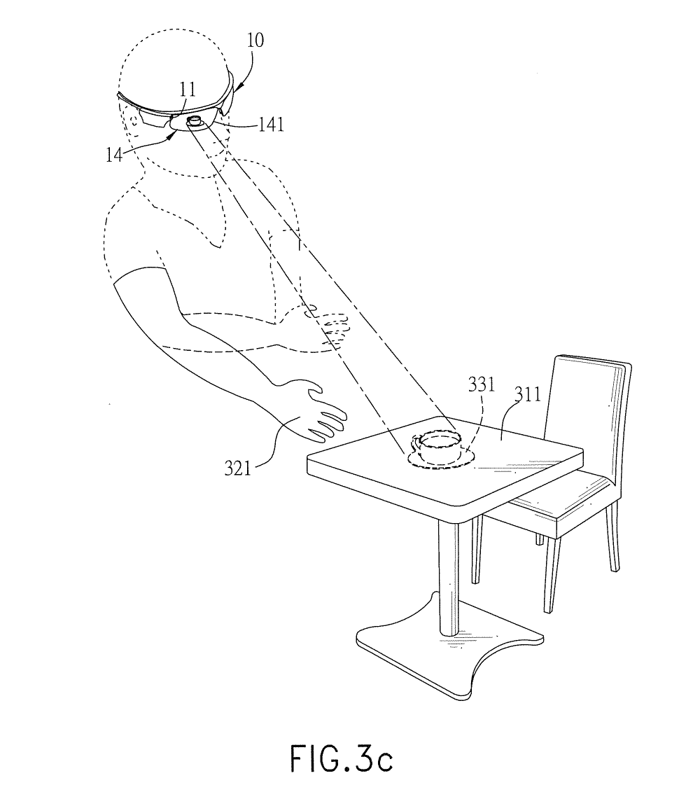

With reference to FIG. 4, a second embodiment of a head wearable electronic device 10a for augmented reality in accordance with the present invention is substantially the same as the foregoing embodiment except that the head wearable electronic device for augmented reality 10a has two image acquisition modules 11a and two see-through display modules 14a. The two image acquisition modules 11a can respectively acquire two FPV streaming videos of the surrounding environment from two different perspectives on a real-time basis to generate the visual effect of both eyes of human. When images captured in each FPV streaming videos include objects and body portions or when each image acquisition module 11a acquires the FPV streaming video containing objects and body portions, the processing module adopts a stereo matching algorithm to obtain disparity values between the two streaming videos for calculating a stream of depth maps of the objects and the body portions so as to generate more accurate depth maps. The stereo matching algorithm analyzes two streaming videos taken in parallel and determines a stream of depth maps of objects in the streaming videos according to a theory that a closer object has a larger displacement than a farther object in the streaming videos. Besides, the two see-through display modules 14a respectively display two virtual streaming videos viewed by the left eye and the right eye of the user. Given the parallax between the eyes, the displayed virtual streaming videos can generate a 3D visual effect for the virtual objects to be closely integrated to the surrounding environment.

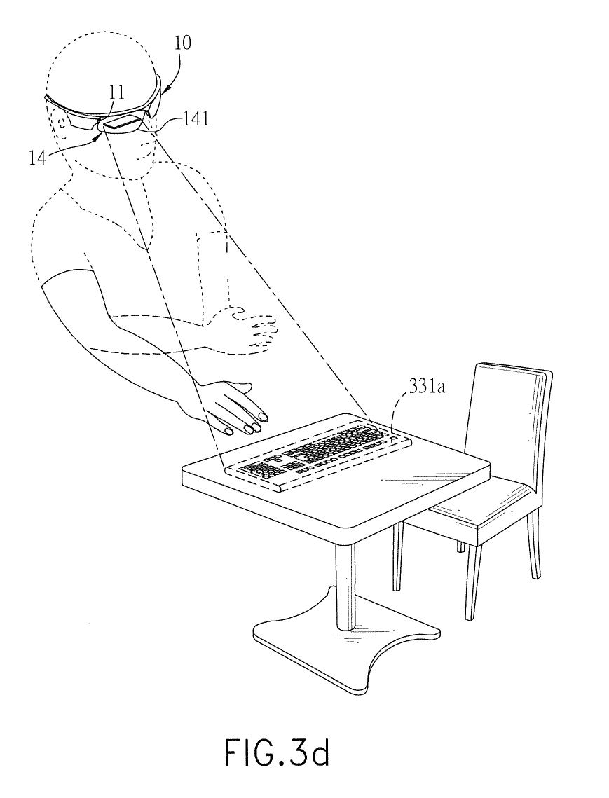

With reference to FIG. 5, the second embodiment of the head wearable electronic device 10b further has a motion-sensing module 15 to sense an orientation, a location or a motion of a user's head. The motion-sensing module 15 may be a gyroscope, an accelerometer, a magnetometer or any combination of the gyroscope, the accelerometer and the magnetometer. As the head wearable electronic device 10b is fixedly worn on a user's head, when the user turns his/her head to see different surrounding environments, the motion-sensing module 15 synchronously outputs head reference data. When the processing module 12 receives the head reference data, two corresponding effects are available as follows.

A first effect is that the processing module 12 outputs another virtual streaming video to the see-through display module 14. Such effect can be implemented by incorporating a GPS (Global Positioning System) module into the head wearable electronic device 10b. Suppose that the original augmented reality content is used to dynamically display a map or scene data with respect to north. After the user's head is turned, the augmented reality content may be changed to dynamically display the map or the scene data with respect to east or west. Alternatively, after the user's head turns, a corresponding virtual streaming video with another display content is displayed to generate an effect, such as a page-swapping effect of an operation interface of a smart phone.

A second effect is that the processing module 12 adjusts a display position of the original virtual streaming video on the see-through display module 14 according to the head reference data. The second effect can be implemented by similarly incorporating the GPS module into the head wearable electronic device. In other words, after the user's head turns, the locations of the coffee table in the original streaming video also varies. Meanwhile, the display locations of the coffee cup on the see-through display module can be changed according to the head reference data such that the coffee cup seems still located on the coffee table and the augmented virtual data can be combined in a more vivid fashion.

The processing module can display a streaming video of a 3D environment map on the see-through display module according to 3D environment map data for users to view displayed content including a streaming video of the 3D surrounding environment and a streaming video of a 3D virtual environment or a 3D virtual map corresponding to the 3D surrounding environment. Such application enhances quantities and quality of acquired data and can be applied to military field, such as combination of body heat data sensed by satellite and the surrounding environment for users to see through a wall to identify any enemy behind the wall in an augmented reality content. Moreover, the foregoing application can be applied to 3D augmented reality games such that users can integrate electronic games into real living environments.

The 3D environment map data can be further processed by using the foregoing stream of depth maps. Specifically, while users move in a surrounding environment, the processing module 12 not only can instantly process a stream of depth maps, that is, multiple depth map images, but also can process the streaming video provided by the image acquisition module 11 to obtain multiple sets of environmental chromaticity data, that is, chromaticity diagram.

There are three types of options for displaying the augmented reality content on the see-through display module 14, namely, (1) display at fixed x and y coordinates, (2) display based on 3D coordinates of a 3D model of a 3D surrounding environment, and (3) display centered at a rotation center of user's head. In option 2, a 3D simultaneous localization and mapping (SLAM) algorithm is used to generate the 3D environment map data and simultaneously keep track of user's locations and visual angles in a 3D indoor space, which are taken as references to position the augmented reality content. For situations in outdoor environments, in addition to the SLAM algorithm, a GPS device is additionally required. In option 3, information measured by the motion-sensing module 15 is taken as head reference data to position the augmented reality content. Specifically, the gyroscope is used to detect angular rotation (roll: tilting sideways; yaw: turning sideways; pitch: tilting up/down), the accelerometer is used to measure acceleration along X, Y and Z axes in a real 3D space, and the magnetometer is used to measure information of magnetic lines of earth to identify an orientation of the magnetic field. In collaboration with the head reference data outputted from the gyroscope, the accelerometer, the magnetometer or any combination of the gyroscope, the accelerometer and the magnetometer of the motion-sensing module 15, the augmented reality content can be displayed in a more accurate manner correlating to the 3D environment map data.

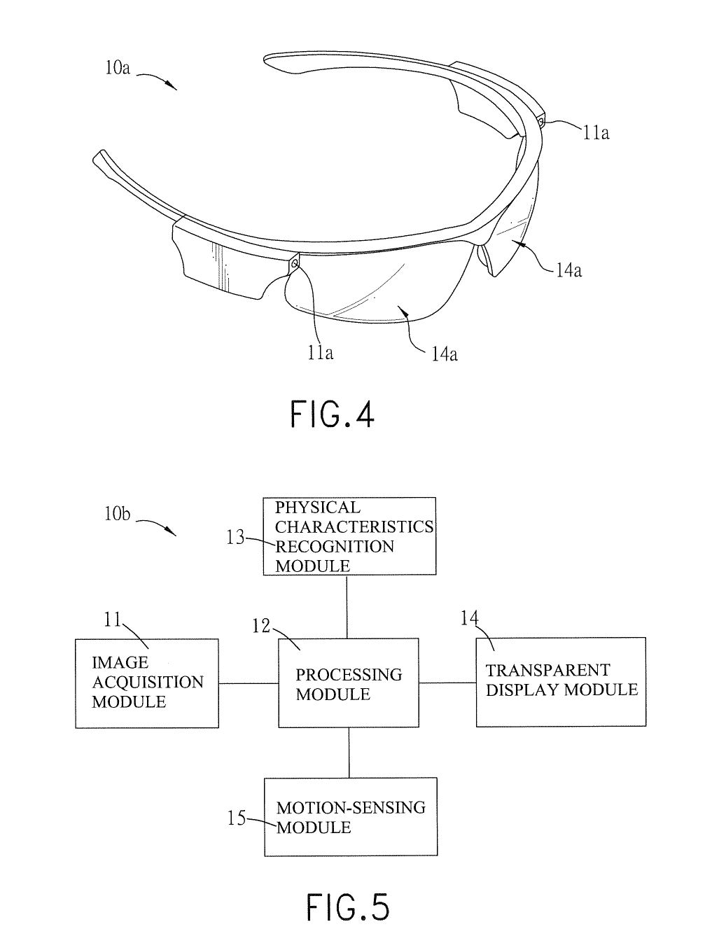

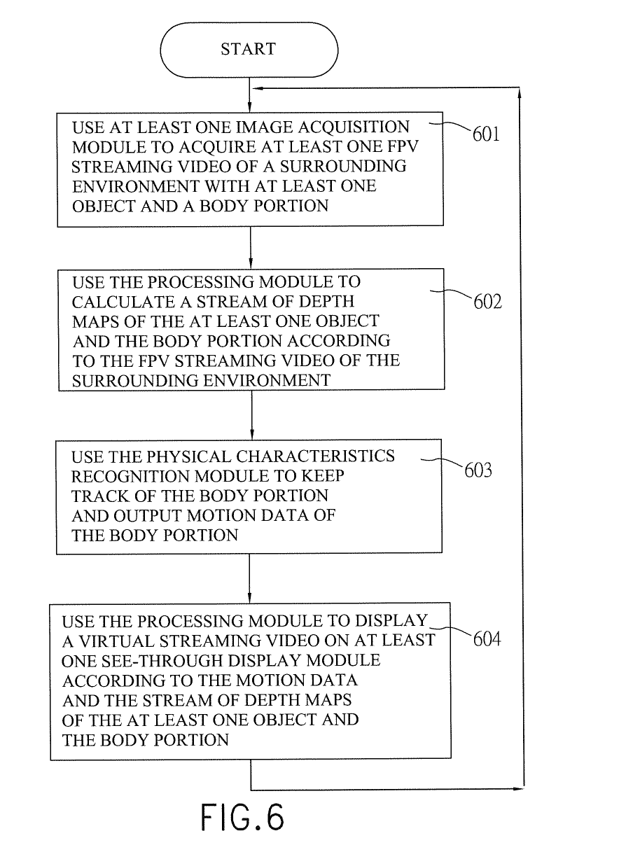

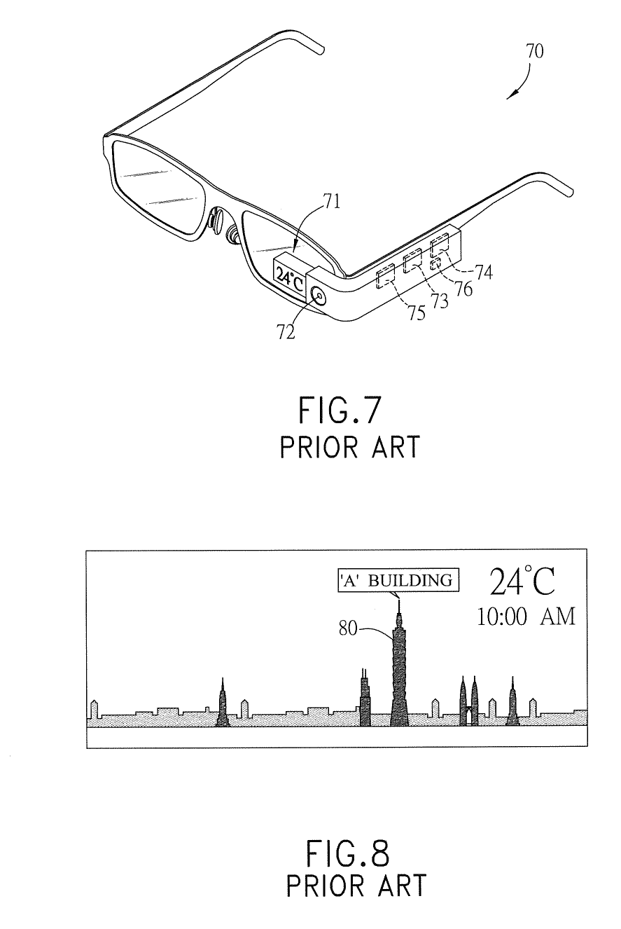

With reference to FIG. 6, a method for generating augmented reality in accordance with the present invention is performed by the foregoing head wearable electronic device and has the following steps.

Step 601: Use at least one image acquisition module to acquire at least one FPV streaming video of a surrounding environment with at least one object and a body portion.

Step 602: Use the processing module to calculate a stream of depth maps of the at least one object and the body portion according to the FPV streaming video of the surrounding environment.

Step 603: Use the physical characteristics recognition module to keep track of the body portion and output motion data of the body portion.

Step 604: Use the processing module to display a virtual streaming video on at least one see-through display module according to the motion data and the stream of depth maps of the at least one object and the body portion.

In sum, the head wearable electronic device for augmented reality and the method for generating augmented reality calculate the depth maps of all objects and a body portion in the surrounding environment through the image acquisition module and the processing module in real time. Given the physical characteristics recognition module for keeping track of user's motion, a 3D interactive relationship is established between users and the objects in the surrounding environment. In other words, supposing that the objects are located at different locations relative to a user in the surrounding environment and when user's hand moves different distances, the head wearable electronic device for augmented reality and the method for generating augmented reality determine that the user's hand tries to interact with different objects and provides the user with different augmented contents to closely combine the FPV streaming video of surrounding environment with virtual streaming video of objects in the surrounding environment.

Additionally, the head wearable electronic device has two see-through display modules serving to generate a 3D virtual streaming video using the binocular disparity and further enhancing a 3D interactive effect between users and the surrounding environment. Furthermore, the head wearable electronic device further has a motion-sensing module to get the hold of motion data, such as user's location, head-turning direction or movement, so as to vary or adjust virtual images at any time. Accordingly, users can experience virtual streaming video generated by way of augmented reality and corresponding to any type of 3D space from the perspective of users themselves.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for generating augmented reality performed by a head wearable electronic device having at least one image acquisition module, a physical characteristics recognition module, at least one see-through display module, and a processing module, the method comprising steps of:
using the at least one image acquisition module to acquire at least one first-person view (FPV) streaming video of a surrounding environment;
using the processing module to calculate a stream of depth maps of at least one object and a body portion in the at least one FPV streaming video of the surrounding environment according to the at least one FPV streaming video of the surrounding environment;
using the physical characteristics recognition module to keep track of the body portion and output motion data of the body portion; and
using the processing module to display at least one virtual streaming video on the respective see-through display module according to the motion data and the stream of depth maps of the at least one object and the body portion.

2. The method as claimed in claim 1, wherein the processing module calculates the stream of depth maps of the at least one object and the body portion using an optical flow algorithm.

3. The method as claimed in claim 1, wherein the head wearable electronic device has two image acquisition modules respectively taking two FPV streaming videos of the surrounding environment with the at least one object and the body portion, the processing module obtains disparity values between the two streaming videos of the surrounding environment using a stereo matching algorithm to calculate the stream of depth maps of the at least one object and the body portion.

4. The method as claimed in claim 1, wherein the head wearable electronic device further has a motion-sensing module adapted to sense an orientation, a location or a motion of a user's head so as to output head reference data, and the processing module outputs another at least one virtual streaming video to the respective see-through display module according to the head reference data.

5. The method as claimed in claim 1, wherein the head wearable electronic device further has a motion-sensing module adapted to sense an orientation, a location or a motion of a user's head so as to output head reference data, and the processing module adjusts at least one display position of the at least one virtual streaming video on the respective see-through display module according to the head reference data.

6. The method as claimed in claim 1, wherein the physical characteristics recognition module keeps track of the body portion surrounding environment by extracting the body portion from the FPV image of the surrounding environment according to contour, shape, color, distance of the body portion, converting the stream of depth maps of a part of the body portion into a 3D (three-dimensional) point cloud, mapping a built-in or received 3D model to the 3D point cloud with a model-based hand tracking algorithm, and comparing locations of the body portion within a period of time.

7. The method as claimed in claim 1, further comprising a step of using the processing module to display a streaming video on each of the at least one see-through display module according to 3D environment maps.

8. The method as claimed in claim 7, wherein data of the 3D environment map are calculated by the processing module according to the stream of depth maps and multiple sets of environmental chromaticity data of the surrounding environment.

9. The method as claimed in claim 1, wherein the head wearable electronic device has two see-through display modules respectively displaying two virtual streaming videos on the two see-through display modules.

10. A head wearable electronic device for augmented reality, comprising:
at least one image acquisition module respectively acquiring at least one first-person view (FPV) streaming video of a surrounding environment, wherein the at least one FPV streaming video of the surrounding environment includes at least one object and a body portion;
a processing module coupled to the at least one image acquisition module, and calculating a stream of depth maps of the at least one object and the body portion surrounding environment according to the at least one FPV streaming video of the surrounding environment;
a physical characteristics recognition module coupled to the processing module, keeping track of the body portion in the at least one FPV streaming video of the surrounding environment, and outputting motion data corresponding to the body portion; and
at least one see-through display module coupled to the processing module, and displaying at least one virtual streaming video on the respective see-through display module according to the motion data and the stream of depth maps of the body portion.

11. The device as claimed in claim 10, wherein the processing module calculates the stream of depth maps of the at least one object and the body portion using an optical flow algorithm.

12. The device as claimed in claim 10, wherein the at least one image acquisition module includes two image acquisition modules respectively taking two FPV streaming videos of the surrounding environment each FPV streaming video including the at least one object and the body portion, the processing module obtains disparity values between the two FPV streaming videos using a stereo matching algorithm to calculate the stream of depth maps of the at least one object and the body portion.

13. The device as claimed in claim 10, further comprising a motion-sensing module coupled to the processing module, and adapted to sense an orientation, a location or a motion of a user's head so as to output head reference data, and the processing module respectively outputs another at least one virtual streaming video to the respective see-through display module according to the head reference data.

14. The device as claimed in claim 10, further comprising a motion-sensing module coupled to the processing module, and adapted to sense an orientation, a location or a motion of a user's head so as to output head reference data, and the processing module respectively adjusts at least one display position of the at least one virtual streaming video on the respective see-through display module according to the head reference data.

15. The device as claimed in claim 10, wherein the physical characteristics recognition module keeps track of the body portion in the at least one FPV streaming video of the surrounding environment by recognizing the body portion according to contour, shape, color, distance of the body portion, converting the stream of depth maps of a part of the body portion into a 3D (three-dimensional) point cloud, mapping a built-in or received 3D model to the 3D point cloud with a model-based hand tracking algorithm, and comparing locations of the body portion within a period of time.

16. The device as claimed in claim 10, wherein the processing module displays a streaming video on each of the at least one see-through display module according to 3D environment maps.

17. The device as claimed in claim 16, wherein data of the 3D environment map are calculated by the processing module according to the stream of depth maps and multiple sets of environmental chromaticity data of the surrounding environment.

18. The device as claimed in claim 10, wherein the at least one see-through display module includes two see-through display modules respectively displaying two virtual streaming videos on the two see-through display modules.
